(19) United States
(12) Patent Application Publication
(10) Pub. No.: US 2015/0081570 A1
(43) Pub. Date: Mar. 19, 2015

(54) CUSTOMER PREFERENCE MANAGEMENT AND NOTIFICATION SYSTEMS

(71) Applicant: Ramana Murthy Gedela, Princeton, NJ (US)

(72) Inventor: Ramana Murthy Gedela, Princeton, NJ (US)

(21) Appl. No.: 14/484,786

(22) Filed: Sep. 12, 2014

Related U.S. Application Data
(60) Provisional application No. 61/877,886, filed on Sep. 13, 2013.

(51) Int. Cl. G06Q 30/00; G06Q 30/02

(52) U.S. Cl. CPC G06Q 30/01; G06Q 30/0281
USPC 705/304

(57) ABSTRACT

A customer preference and notification system may include a program in operative communication with an ERP system and a CRM system. Customer preferences may be stored in an expanded data store accessible by the program, the ERP system, and the CRM system. Notifications may be triggered by events associated with business processes, and may be sent via one or more channels based on the customer preferences.

### CROSS-REFERENCES

This application claims the benefit of U.S. Provisional Patent Application Ser. No. 61/877,886, which was filed on Sep. 13, 2013 and entitled “Customer Preferences Management Systems.” The complete disclosure of the above application is hereby incorporated by reference for all purposes.

The following related applications and materials are incorporated herein, in their entireties, for all purposes: U.S. Pat. Nos. 8,661,103; 6,915,270; and 5,960,411; and U.S. Patent Application Publication Nos. 2014/0189087, 2014/0108318, 2014/0040038, and 2013/0262168.

### INTRODUCTION

Companies may use one or more software systems to manage interactions with current and future customers and/or to perform key business functions. For example, companies may use Customer Relationship Management (CRM) software, such as CRM software made, among others, by the company Systems Applications Products in Data Processing (SAP), to organize, automate, and synchronize sales, marketing, customer service, and/or technical support. Companies may additionally, or alternatively, use Enterprise Resource Planning (ERP) software, such as SAP's ERP Central Component (ECC), that provides an integrated real-time view of core business processes (such as cash, raw materials, and production capacity) and the status of commitments (such as customer orders, purchase orders, and employee payroll). CRM may be a standalone program, or in many examples, CRM may comprise an integrated or modular addition to ERP software.

Many businesses utilize CRM software to keep track of marketing preferences. For example, SAP's CRM allows a company to record whether any given customer (also referred to as a business partner) has agreed to receive marketing communications from the company. In many places, this sort of permission is required by law. However, communications other than marketing are frequently desired by the company, the business partner, or both. These additional communications may involve obtaining permission and/or preferred communication method from the customer. Existing CRM systems (such as SAP's CRM system) do not include features for tracking and automatically acting upon these sorts of permissions and preferences.

### SUMMARY

The present disclosure provides a method for managing customer communication preferences. In some embodiments, the method may include monitoring, by an electronic apparatus, a plurality of events associated with a plurality of customers, and detecting, by the electronic apparatus, a first event associated with a first customer. In some embodiments, the method may include determining, by the electronic apparatus and from an electronic database, that the first customer has a stored preferred channel associated with communication of the first event to the first customer. In some embodiments, the method may include directing, by the electronic apparatus, the communication of the first event to the first customer via the stored preferred channel associated with communication of the first event to the first customer.

The present disclosure also provides a computer system for managing customer communication preferences. The computer system includes a processor and a memory. The computer system also includes a program comprising a plurality of instructions stored in the memory. In some embodiments, the plurality of instructions is executed by the processor to monitor a plurality of events associated with a plurality of customers, and detect a first event associated with a first customer. In some embodiments, the plurality of instructions is executed by the processor to determine that the first customer has a stored preferred channel associated with communication of the first event to the first customer. In some embodiments, the plurality of instructions is executed by the processor to direct the communication of the first event to the first customer via the stored preferred channel associated with communication of the first event to the first customer.

The present disclosure further provides a computer program product for managing customer communication preferences. The computer program product comprises at least one computer readable storage medium having computer readable program instructions embodied therewith. In some embodiments, the computer readable program instructions, when read by a processor, is configured to monitor a plurality of events associated with a plurality of customers, and detect a first event associated with a first customer. In some embodiments, the computer readable program instructions, when read by a processor, is configured to determine that the first customer has a stored preferred channel associated with communication of the first event to the first customer. In some embodiments, the computer readable program instructions, when read by a processor, is configured to direct the communication of the first event to the first customer via the stored preferred channel associated with communication of the first event to the first customer.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of various components of an illustrative data processing system suitable for use with aspects of the present disclosure.

FIG. 2 is a schematic representation of an illustrative computer network system.

FIG. 3 is a schematic diagram of a customer preference management and notification system (CPMNS) in accordance with aspects of the present disclosure.

FIG. 4 is a schematic diagram showing an illustrative data structure suitable for use in a CPMNS.

FIG. 5 is a flow chart illustrating steps performed in an illustrative method of managing customer preferences and triggering corresponding actions.

FIG. 6 is a flowchart illustrating steps performed in an illustrative method of event monitoring and responding to events.

### DESCRIPTION

### Overview

Various embodiments of a customer preference management and notification system (CPMNS) suitable for use with a customer relationship management (CRM) software program are described below and illustrated in the associated drawings. Unless otherwise specified, a CPMNS and/or its various components may contain at least one of the structure, components, functionality, and/or variations described, illustrated, and/or incorporated herein. Furthermore, the structures, components, functionalities, and/or variations described, illustrated, and/or incorporated herein in connection with the present teachings may be included in other CRM-related systems. The following description of various embodiments is merely illustrative in nature and is in no way intended to limit the disclosure, its application, or uses. Additionally, the advantages provided by the embodiments, as described below, are illustrative in nature and not all embodiments provide the same advantages or the same degree of advantages.

A CPMNS may include a module or modules configured to work with a CRM system. These modules may create a database, expand an existing CRM database, and/or create one or more tables operatively connected to a database, such that the CPMNS can store and modify information regarding the preferences of one or more customers (also referred to as contacts and/or business partners). These preferences may include a customer's preferred channel or channels of communication regarding notifications to be sent or triggered upon occurrence of one or more events. When the event is performed or executed electronically, the event may sometimes be referred to as an “electronic action.”

Each of these events may be related to one or more business activities or processes (also referred to as business objects in some ERP implementations). For example, a customer may prefer to be notified by email (channel) when a payment has been credited to the customer's account (event) in the billing process (business activity). In some examples, a customer may prefer to be notified via multiple channels (e.g., email and SMS message) about the same event. Alternatively, a customer may prefer not to receive any notification relating to a specific event, or any combination of these examples. Accordingly, the CPMNS may monitor the ERP business processes for selected events, and then compare the events to the notification preferences of the customers. Notifications may then be triggered automatically and/or executed automatically. For example, appropriate email notifications may be automatically sent to customers using native emailing functionality of a CRM system.

Aspects of a CPMNS in accordance with the present disclosure may be embodied as a computer method, computer system, or computer program product. Accordingly, aspects of the present disclosure may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the present disclosure may take the form of a computer program product embodied in a computer-readable medium (or media) having computer readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the present invention may be written in one or any combination of programming languages, including an object-oriented programming language such as Java, Smalltalk, C++, and/or the like, and conventional procedural programming languages, such as the C programming language. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the present invention are described below with reference to flowchart illustrations and/or block diagrams of methods, apparatuses, systems, and/or computer program products according to aspects of the present disclosure. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions can also be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks.

Any flowchart and/or block diagram in the drawings is intended to illustrate the architecture, functionality, and/or operation of possible implementations of systems, methods, and computer program products according to aspects of the present disclosure. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### EXAMPLES, COMPONENTS, AND ALTERNATIVES

The following examples describe selected aspects of illustrative customer preference management and notification (CPMN) systems as well as related systems and/or methods. These examples are intended for illustration and should not be interpreted as limiting the entire scope of the present disclosure. Each example may include one or more distinct inventions, and/or contextual or related information, function, and/or structure.

### Example 1

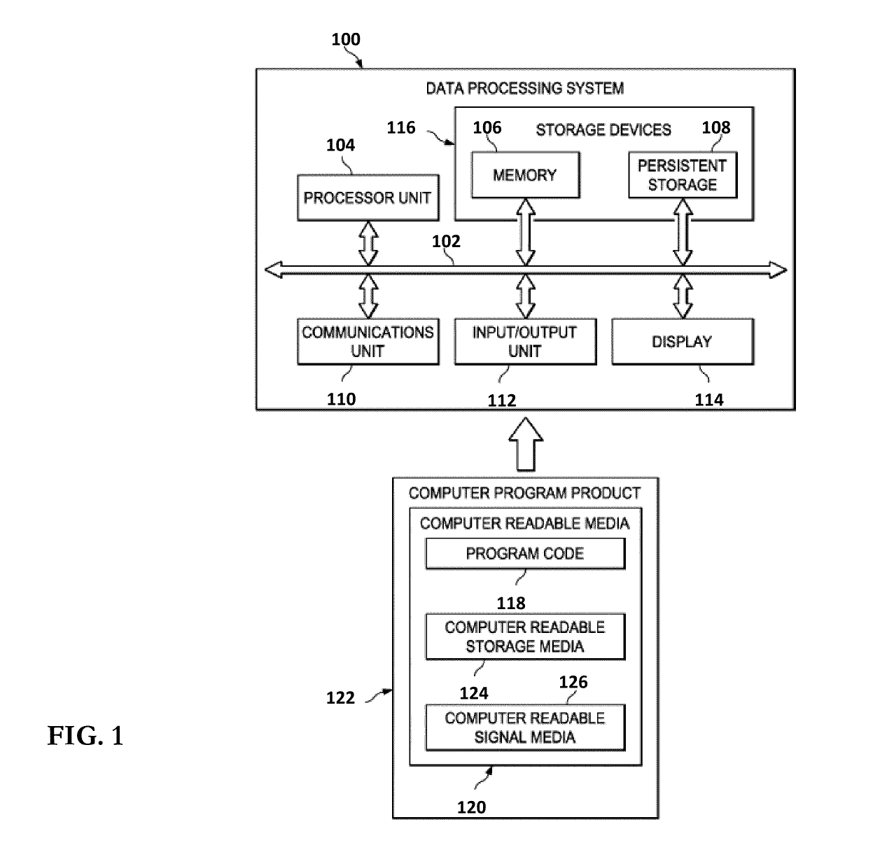

This example describes a data processing system (e.g., a computer) 100 in accordance with aspects of the present disclosure. In this example, data processing system 100 is an illustrative computing system for implementing all or a portion of a CPMNS; See FIG. 1.

In this illustrative example, data processing system 100 includes communications framework 102. Communications framework 102 provides communications between processor unit 104, memory 106, persistent storage 108, communications unit 110, input/output (I/O) unit 112, and display 114. Memory 106, persistent storage 108, communications unit 110, input/output (I/O) unit 112, and display 114 are examples of resources accessible by processor unit 104 via communications framework 102.

Processor unit 104 serves to run instructions that may be loaded into memory 106. Processor unit 104 may be a number of processors, a multi-processor core, or some other type of processor, depending on the particular implementation. Further, processor unit 104 may be implemented using a number of heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example, without limitation, data, program code in functional form, and other suitable information either on a temporary basis or a permanent basis.

Storage devices 116 also may be referred to as computer readable storage devices in these examples. Memory 106, in these examples, may be, for example, a random access memory or any other suitable volatile or non-volatile storage device. Persistent storage 108 may take various forms, depending on the particular implementation.

For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output (I/O) unit 112 allows for input and output of data with other devices that may be connected to data processing system 100. For example, input/output (I/O) unit 112 may provide a connection for user input through a keyboard, a mouse, and/or some other suitable input device. Further, input/output (I/O) unit 112 may send output to a printer. Display 114 provides a mechanism to display information to a user.

Instructions for the operating system, applications, and/or programs may be located in storage devices 116, which are in communication with processor unit 104 through communications framework 102. In these illustrative examples, the instructions are in a functional form on persistent storage 108. These instructions may be loaded into memory 106 for execution by processor unit 104. The processes of the different embodiments may be performed by processor unit 104 using computer-implemented instructions, which may be located in a memory, such as memory 106.

These instructions are referred to as program instructions, program code, computer usable program code, or computer readable program code that may be read and executed by a processor in processor unit 104. The program code in the different embodiments may be embodied on different physical or computer readable storage media, such as memory 106 or persistent storage 108.

Program code 118 is located in a functional form on computer readable media 120 that is selectively removable and may be loaded onto or transferred to data processing system 100 for execution by processor unit 104. Program code 118 and computer readable media 120 form computer program product 122 in these examples. In one example, computer readable media 120 may be computer readable storage media 124 or computer readable signal media 126.

Computer readable storage media 124 may include, for example, an optical or magnetic disk that is inserted or placed into a drive or other device that is part of persistent storage 108 for transfer onto a storage device, such as a hard drive, that is part of persistent storage 108. Computer readable storage media 124 also may take the form of a persistent storage, such as a hard drive, a thumb drive, or a flash memory, that is connected to data processing system 100. In some instances, computer readable storage media 124 may not be removable from data processing system 100.

In these examples, computer readable storage media 124 is a physical or tangible storage device used to store program code 118 rather than a medium that propagates or transmits program code 118. Computer readable storage media 124 is also referred to as a computer readable tangible storage device or a computer readable physical storage device. In other words, computer readable storage media 124 is a media that can be touched by a person.

Alternatively, program code 118 may be transferred to data processing system 100 using computer readable signal media 126. Computer readable signal media 126 may be, for example, a propagated data signal containing program code 118. For example, computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 118 may be downloaded over a network to persistent storage 108 from another device or data processing system through computer readable signal media 126 for use within data processing system 100. For instance, program code stored in a computer readable storage medium in a server data processing system may be downloaded over a network from the server to data processing system 100. The data processing system providing program code 118 may be a server computer, a client computer, or some other device capable of storing and transmitting program code 118.

The different components illustrated for data processing system 100 are not meant to provide architectural limitations to the manner in which different embodiments may be implemented. The different illustrative embodiments may be implemented in a data processing system including components in addition to and/or in place of those illustrated for data processing system 100. Other components shown in FIG. 1 can be varied from the illustrative examples shown. The different embodiments may be implemented using any hardware device or system capable of running program code. As one example, data processing system 100 may include organic components integrated with inorganic components and/or may be comprised entirely of organic components excluding a human being. For example, a storage device may be comprised of an organic semiconductor.

In another illustrative example, processor unit 104 may take the form of a hardware unit that has circuits that are manufactured or configured for a particular use. This type of hardware may perform operations without needing program code to be loaded into a memory from a storage device to be configured to perform the operations.

For example, when processor unit 104 takes the form of a hardware unit, processor unit 104 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a field programmable logic array, a field programmable gate array, and other suitable hardware devices. With this type of implementation, program code 118 may be omitted, because the processes for the different embodiments are implemented in a hardware unit.

In still another illustrative example, processor unit 104 may be implemented using a combination of processors found in computers and hardware units. Processor unit 104 may have a number of hardware units and a number of processors that are configured to run program code 118. With this depicted example, some of the processes may be implemented in the number of hardware units, while other processes may be implemented in the number of processors.

In another example, a bus system may be used to implement communications framework 102 and may be comprised of one or more buses, such as a system bus or an input/output bus. Of course, the bus system may be implemented using any suitable type of architecture that provides for a transfer of data between different components or devices attached to the bus system.

Additionally, communications unit 110 may include a number of devices that transmit data, receive data, or both transmit and receive data. Communications unit 110 may be, for example, a modem or a network adapter, two network adapters, or some combination thereof. Further, a memory may be, for example, memory 106, or a cache, such as that found in an interface and memory controller hub that may be present in communications framework 102. Data processing system 100 may sometimes be referred to as an “electronic apparatus.”

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

### Example 2

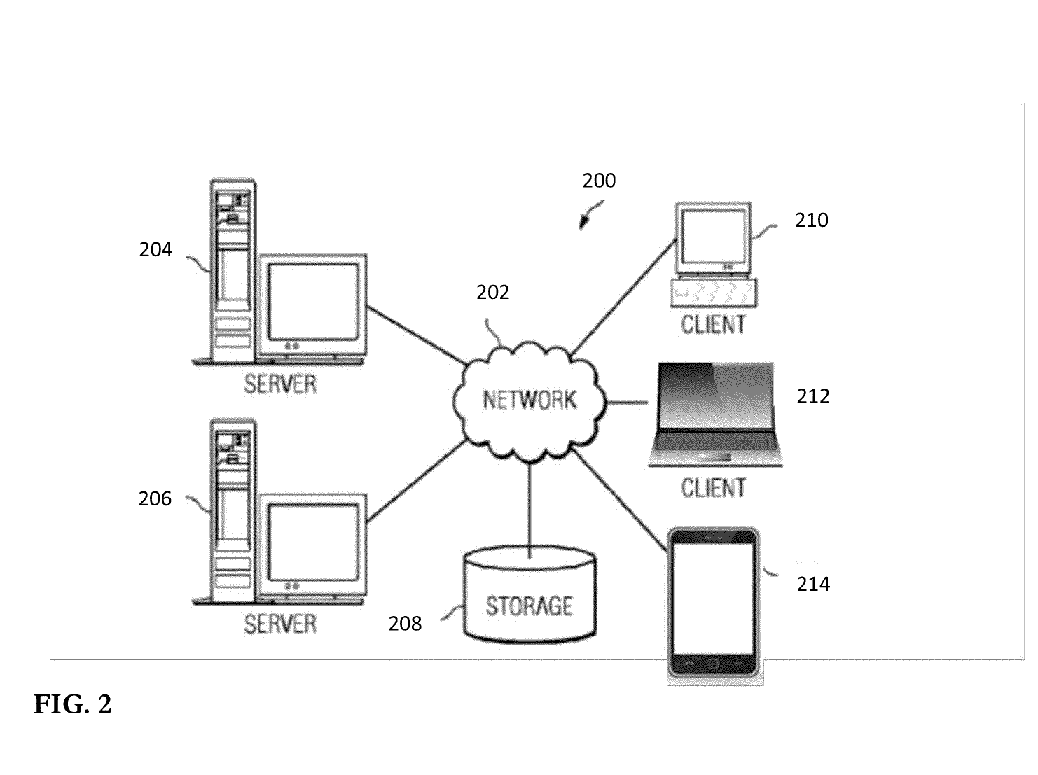

This example describes a general network data processing system 200, interchangeably termed a network, a computer network, a network system, or a distributed network, in which illustrative embodiments of a CPMNS may be implemented; see FIG. 2. It should be appreciated that FIG. 2 is provided as an illustration of one implementation and is not intended to imply any limitation with regard to environments in which different embodiments may be implemented. Many modifications to the depicted environment may be made.

Network data processing system 200 is a network of computers and other components in which one or more illustrative embodiments of a malware-resistant data storage system may be implemented. Network data processing system 200 may include network 202, which is a medium configured to provide communications links between various devices and computers connected together within network data processing system 200. Network 202 may include connections such as wired or wireless communication links, fiber optic cables, and/or any other suitable medium for transmitting and/or communicating data between network devices, or any combination thereof.

In the depicted example, a first network device 204 and a second network device 206 connect to network 202, as does an electronic storage device 208. In the depicted example, devices 204 and 206 are shown as server computers. However, network devices may include, without limitation, one or more personal computers, mobile computing devices such as personal digital assistants (PDAs), tablets, and smart phones, handheld gaming devices, wearable devices, tablet computers, routers, switches, voice gates, servers, electronic storage devices, imaging devices, and/or other networked-enabled tools that may perform a mechanical or other function. These network devices may be interconnected through wired, wireless, optical, and other appropriate communication links.

In addition, client electronic devices, such as devices 210, 212, and 214, may connect to network 202. Client electronic devices 210, 212, and 214 may include, for example, one or more personal computers, network computers, and/or mobile computing devices, such as personal digital assistants (PDAs), smart phones, handheld gaming devices, wearable devices, and/or tablet computers, and the like. In the depicted example, server 204 provides information, such as boot files, operating system images, and applications to one or more of client electronic devices 210, 212, and 214. Client electronic devices 210, 212, and 214 may be referred to as “clients” with respect to a server such as server computer 204. Network data processing system 200 may include more or fewer servers and clients or no servers or clients, as well as other devices not shown.

Program code located in system 200 may be stored in or on a computer recordable storage medium and may be downloaded to a data processing system or other device for use. For example, program code may be stored on a computer recordable storage medium on server computer 204 and downloaded for use to client 210 over network 202 for use on client 210.

Network data processing system 200 may be implemented as one or more of a number of different types of networks. For example, system 200 may include an intranet, a local area network (LAN), a wide area network (WAN), or a personal area network (PAN). In some examples, network data processing system 200 includes the Internet, with network 202 representing a worldwide collection of networks and gateways that use the transmission control protocol/Internet protocol (TCP/IP) suite of protocols to communicate with one another. At the heart of the Internet is a backbone of high-speed data communication lines between major nodes or host computers.

Thousands of commercial, governmental, educational and other computer systems may be utilized to route data and messages. FIG. 2 is intended as an example, and not as an architectural limitation for any illustrative embodiments.

### Example 3

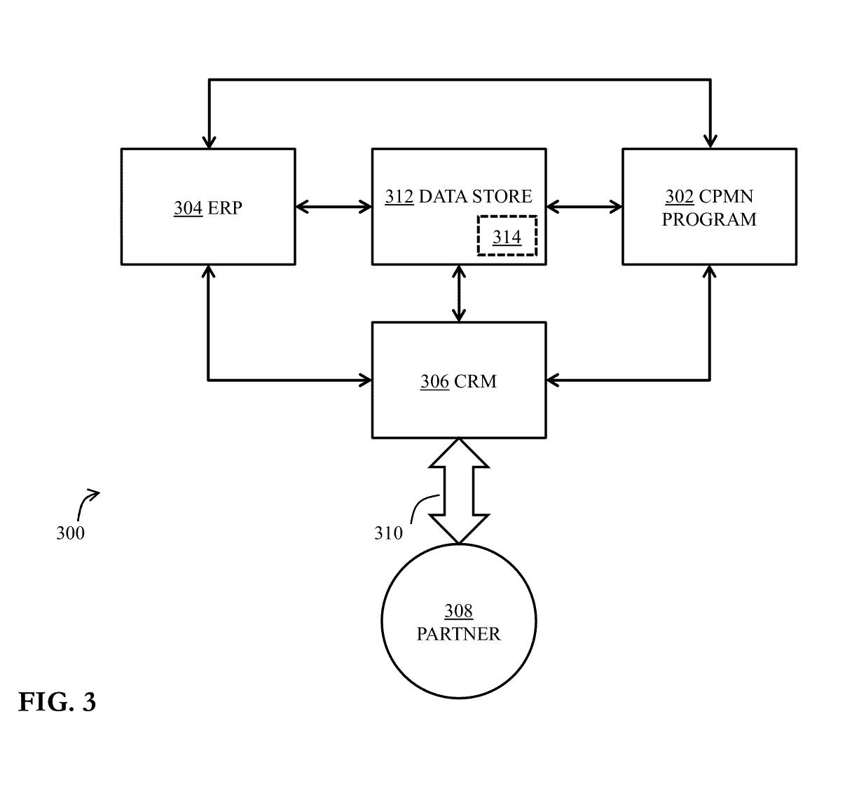

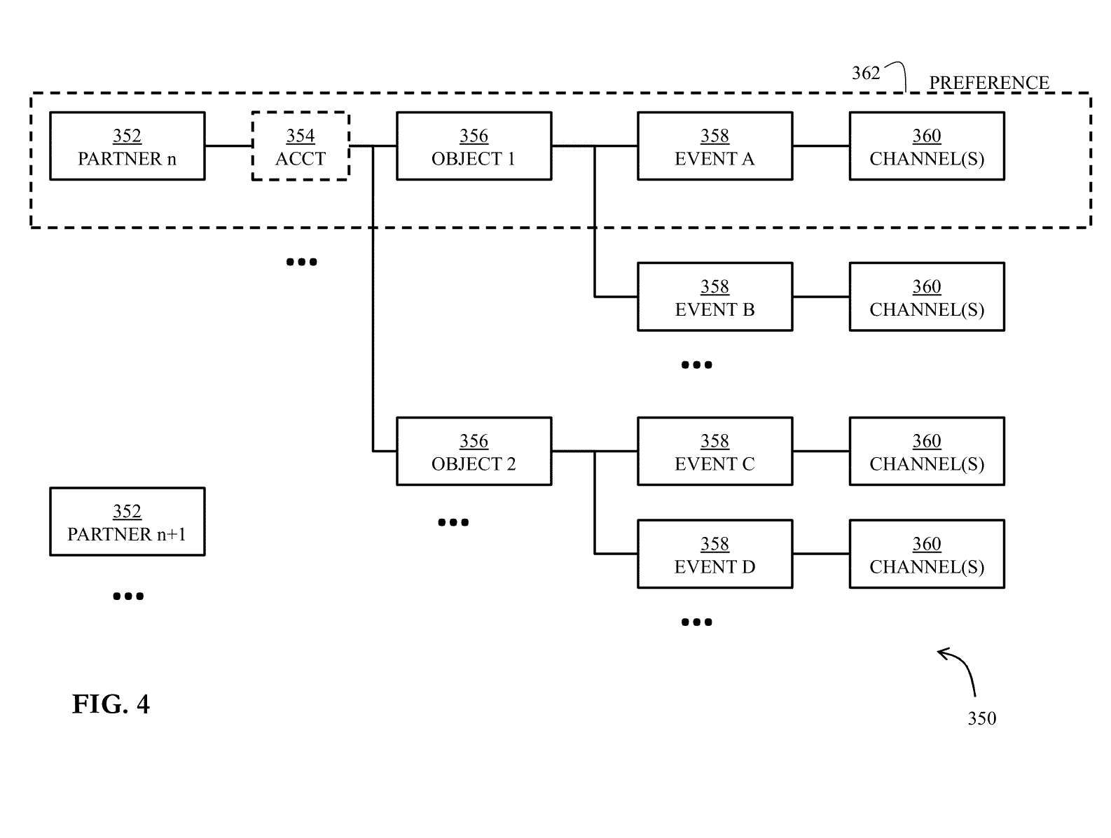

This example describes an illustrative CPMNS implemented in one or more computers such as those described in Examples 1 and 2; see FIGS. 3 and 4.

In this example, a CPMNS is generally indicated at 300 in FIG. 3. CPMNS 300 may include a customer preference management and notification program (CPMNP) 302, in operative communication with an ERP system 304 and a CRM system 306. CPMNP 302 may include any suitable module, circuit, or program configured to communicate with the ERP and/or CRM to store information about customer notification preferences, to monitor actions taken by the ERP, and to trigger actions through the CRM based on the actions and the preferences. Further details regarding method steps suitable for execution by CPMN program 302 are provided in Example 4 below.

Program 302 may be implemented as computer software code. For example, program 302 may comprise one or more scripts written using a native scripting functionality of the ERP and/or CRM. In some examples, program 302 may be a standalone program capable of being plugged into or added onto the CRM and/or ERP. Program 302 may comprise an extension of the ERP and/or CRM. In some examples, some or all of program 302 may be integrated into the CRM and/or ERP.

ERP 304 may include any suitable enterprise resource planning system configured with an interface allowing other computer programs to interact with the ERP. For example, ERP 304 may include an ERP with an application programming interface (API). Suitable examples of such ERPs are provided by companies including SAP, Oracle, and Microsoft.

Likewise, CRM 306 may include any suitable customer relationship management system configured with an interface allowing other computer programs to interact with the ERP. For example, CRM 306 may include an application programming interface (API). Suitable examples of such CRMs are provided by companies including SAP, Oracle, and Microsoft. CRM 306 may be designed to interoperate with ERP 304, or may be considered a part of ERP 304. For example, CRM 306 may be included in an overall suite of program modules intended to be used together with ERP 304.

CRM 306 is typically intended for managing customer relations. Accordingly, the CRM system may comprise one or more ways to communicate with customers. These customers may be referred to interchangeably herein as partners or business partners, and are represented schematically in FIG. 3 at reference number 308. The ways or modes of communicating may be referred to as channels 310. Channels 310 may include communications generated by the CRM automatically or upon demand by a user, as well as information regarding specific communication methods to be carried out by humans or third party programs. For example, channels 310 may include oral communication with a customer service representative, digital communication using online services, interactive voice response, SMS text messaging, non-SMS messaging (such as provided by WhatsApp, Twitter, or Facebook Messenger), email, fax, and/or paper media (i.e., postal mail).

CPMN program 302, ERP 304, and CRM 306 all include functionality that requires access to stored data. For example, each of these programs may store, read, and/or manipulate information related to the customer(s) of a user company. Accordingly, a data store 312 is included in CPMNS 300, and is capable of being accessed, directly or indirectly, by each of the programs 302, 304, and 306. Data store 312 may include any suitable collection of data objects configured to be accessible and/or editable by one or more of the programs described herein. In some examples, data store 312 may include one or more relational databases storing a plurality of records relating to partners 308. Information other than customer information (e.g., manufacturing schedules) may be included in data store 312, either in a common database or in separate databases, tables, spreadsheets, or the like, or any combination of these.

System 300 may be implemented on one or more data processing systems, such as the computers described in Example 1, and may include a network of computers, such as described in Example 2. For example, ERP 304 and CRM 306 may be installed on one or more server computers and accessed remotely by client computers. Data store 312 may be installed on the same or other servers, or may exist in a cloud-based storage system. Likewise, CPMNP 302 may be on a separate computer, or may be stored alongside or with the CRM and/or ERP. Each of the computers described above may interact and communicate over a network, such as a LAN and/or the Internet.

CPMN program 302 may add a database or other data object to data store 312 to include information used by CPMNS 300. In other examples, program 302 may expand one or more of the databases within data store 312 to include the additional information. This additional or expanded data store is indicated at 314 in FIG. 3.

An illustrative schema 350 describing information to be stored in data store 314 is shown in FIG. 4. Suitable data may include information relating to a customer/partner, such as information regarding the partner's preferences as to selected notifications. The notifications, in turn, may each relate to an event associated with a given business process (also referred to as a business object).

Records in schema 350 may include a partner identifier (ID) 352 for each of one or more partners. Typically, partners are included within a standard ERP and/or CRM data store. Accordingly, partner ID 352 may correspond or match an existing partner ID, relating the CPMNS information to that partner in addition to information stored for other purposes. Each partner ID may be associated with one or more accounts, represented by an account ID 354. Account ID 354 may sometimes be referred to as an “object type” or an “account type.” In some examples, partner IDs and account IDs are indistinguishable, such as when a partner is not allowed to have multiple accounts, or when each account is treated by the system as a separate partner. The block illustrating account ID 354 is in dashed outline to indicate that an account ID may be optional.

For a given partner ID and (possibly) account ID, one or more business objects 356 may be relevant. Business objects include any suitable business process that has an effect on the partner, and may include industry-specific business processes. For example, business objects 356 may include billing, payment, usage (such as electricity or data usage), maintenance (such as planned downtime or outages), and/or general (such as customer service and marketing). Note that in some examples, the CRM system may include a mechanism for recording overall marketing permission. For example, SAP's CRM system includes a marketing permission mechanism. That mechanism, which may include a table or data store, may serve as the base for expansion into data store 314.

Additionally, each business object 356 may include one or more events 358 that a partner may be interested in. Each such event 358 may have an associated notification that may be communicated to partner 308 via one or more of channels 310. Schema 350 may, therefore, include one or more channel IDs 360 for each event 358 to record a partner-preferred channel or channels for notifications of that event. Note that a list of preferred channels may include “none,” to indicate that no communication is desired for the event. In other examples, a separate field may be provided to indicate whether communication is desired regarding the event in question. Such a field may include binary information such as “yes” or “no.”

Taken together, a given set including partner ID 352, account ID 354 (if used), object ID 356, event ID 358, and channel ID 360, may define a notification preference 362. Likewise, all such sets for a given partner can be referred to as the notification preferences of that partner. Note that ellipses ( . . . ) are used in FIG. 4 to indicate where additional examples of each data field may exist.

### Example 4

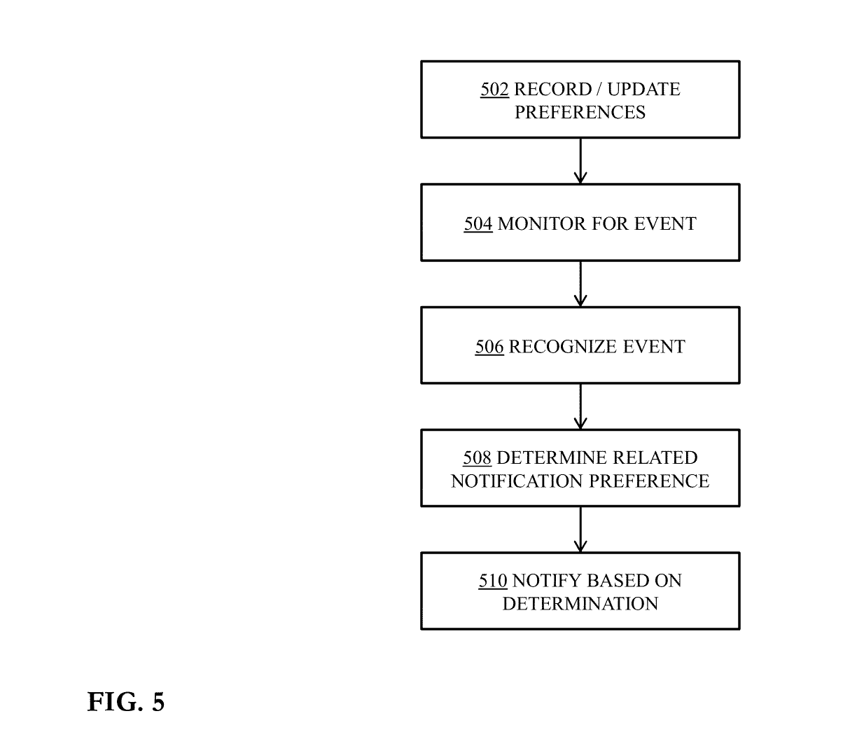

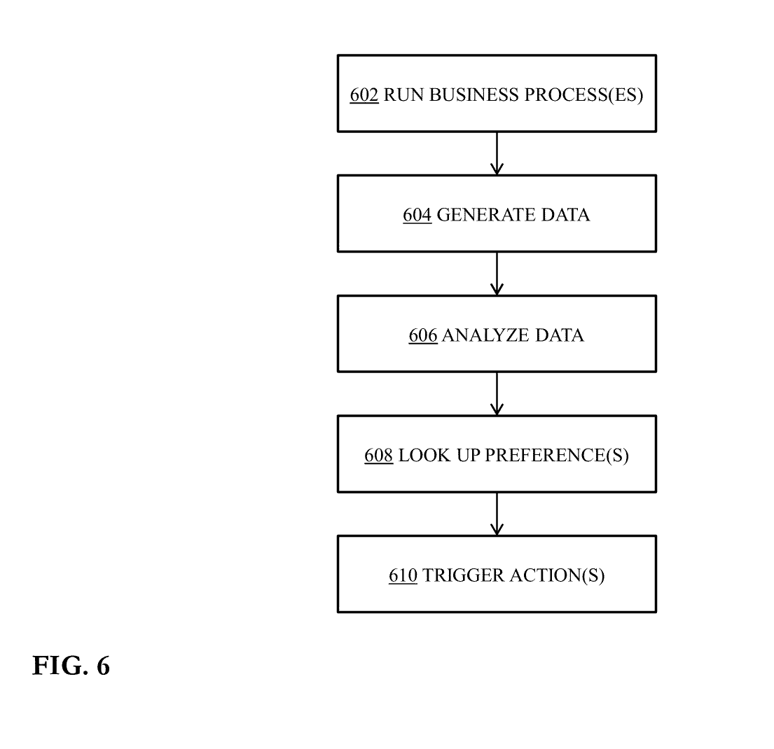

This example describes steps of one or more methods for managing customer preferences and triggering actions based on those preferences; see FIGS. 5 and 6.

FIGS. 5 and 6 are flowcharts illustrating steps performed in one or more illustrative methods, and may not recite the complete process or all steps of each method. FIGS. 5 and 6 depict multiple steps of methods, generally indicated at 500 and 600, which may be performed in conjunction with customer preference management and notification systems according to aspects of the present disclosure. Although various steps of methods 500 and 600 are described below and depicted in FIGS. 5 and 6, the steps need not necessarily all be performed, and in some cases may be performed in a different order than the order shown.

Referring now to FIG. 5, method 500 may include steps to be performed by a customer preference management and notification system, such as by a CPMN program (e.g., program 302 in Example 3). Step 502 of method 500 may include recording customer notification preferences in a data store. Preferences may include any suitable indication of whether and/or by which channel(s) a customer wishes to be notified regarding one or more events having to do with business processes. Recording these preferences in a data store may include expanding an existing data store (e.g., database) and/or creating a new data store, and/or creating relationships between two or more data stores. Expansion or creation of data stores may be performed dynamically on an as-needed basis by the CPMN program. In some examples, expansion or creation of more statically defined data stores may be performed as an initial step.

Step 502 may include modifying preferences already created. For example, a user may indicate a desire to change notification preferences for a given event. Such changes may be made in the data store. In some examples, the changes may be performed on a partner basis, or may be on an account by account basis. For example, a user may indicate that preferences should be changed for all events, for one or more events, one or more business objects, for one or more accounts, and/or any combination of these. A log of historical preferences may be created for each partner and/or account. Furthermore, in some examples, preferences may be modified automatically. For example, a partner activity, such as moving to a new home or changing email addresses, may result in some or all preferences requiring verification and/or additional information from the user and/or partner. As such, notification preferences may be automatically updated, for example to default values or based on input received from the user and/or partner.

Step 502 may include enrolling a partner into a business object-related program, and recording preferences relating to that program. For example, a utility may have a smart meter program for selected customers. Customers who enroll in the program may receive a smart meter and/or different metering rates. Notifications may be associated with the program. Recording preferences regarding such notifications may include determining whether the partner and/or account in question is eligible for that particular program. For example, a partner may have a poor credit rating, which may make that partner ineligible for certain programs and therefore ineligible for certain notifications.

At step 504, the CPMN program monitors for events. For example, the CPMN program may monitor an ERP as it runs business processes. One or more of the business processes may include selected event(s) to be monitored. In other words, these events may correspond to the preferences recorded and/or modified in step 502. Monitoring for events may be performed by any suitable method, and may be performed real-time, near real-time, or on a periodic basis. An illustrative method including monitoring for events is described below regarding FIG. 6.

At step 506 a known event may be recognized by the CPMN program. For example, a list of events may be maintained by the CPMN program (e.g., in an accessible and modifiable data store). As events occur, they may be compared to this list of events to determine whether additional steps should be taken.

At step 508, the CPMN program may determine whether existing partner preferences correspond to the events recognized in step 506. For example, if an event occurs that may affect multiple partners or accounts, then multiple (or all) partner preference records may be reviewed to determine which partner(s) wish to be notified and by which channel(s). For example, if an event occurs specific to a certain partner or subset of partners, then only those partner records may be reviewed to determine notification preferences.

At step 510, partners identified in previous steps may be notified in accordance with their notification preferences. One or more of the channels may be automatic. One or more of the channels of communication may be implemented through the CRM program. For example, an email and/or SMS message may be automatically generated by the CRM system and sent to a partner. For example, a customer service representative may be alerted to communicate orally with the partner(s).

Referring now to FIG. 6, another illustrative method 600 may include steps to be performed by a customer preference management and notification system, such as by a CPMN program (e.g., program 302 in Example 3). Method 600 may generally be described as an event monitoring and response method. At step 602, one or more business processes may be run, such as by an ERP system. For example, an ERP system typically runs billing processes as a scheduled or recurring batch process.

At step 604, data may be generated as a result of or based on the results of the business processes of step 602. For example, a CPMN program may gather data resulting from the business process(es), such as change logs, updates produced, and/or business process actions triggered (e.g., billing statement generated for a certain partner or set of partners). In some examples, the business process may generate the data to be analyzed. In some examples, the data store may be queried to generate the data. A discrete data file may be generated, and may be referred to as an input file.

At step 606, the input file (or other data set generated in step 604) may be analyzed by the CPMN program. For example, the data set may be parsed, sorted, and/or filtered. The data set may be analyzed to further identify partners, business objects, and/or events expected to have corresponding preferences defined in the CPMNS data store.

At step 608, preferences may be determined based on the data set and analysis from steps 604 and 606. For example, the CPMN program may look up the preferences associated with each partner and event identified.

At step 610, actions may be triggered based on the preferences determined in step 608. For example, notifications may be sent by preferred channels to partners who have indicated they wish to receive such notifications by such channels. In some examples, additional actions may be triggered, such as recording the fact that the notification was sent (e.g., in a transaction log) and recording unsuccessful communications (e.g., error messages received when the notifications were sent via e-mail). In some examples, more or fewer notifications may be communicated based on previous actions. For example, it may be desired to notify a partner of the first several occurrences of a certain event, but then to cease such notifications. This sort of provisional notification rubric may be implemented using predefined rules associated with certain event types. These predefined rules may themselves involve preferences that can be changed at the request of a partner. Rule preferences may be stored in the CPMNS data store.

### Example 5

This section describes additional aspects and features of a customer preference management and notification system, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below may expressly refer to and further limit other paragraphs, providing without limitation examples of some of the suitable combinations.

Paragraph 01
Framework and software program for organizations to store partner specific communications preferences received by organization by various communication channels like, telephone call to the customer service representative, organization's web portal, SMS or registered KEYWORDS, interactive voice response system, or by a letter/fax sent to organization. All such preference communications will be received by organization against a specific business process of that partner.
Provide ability for the partner to enroll with a notification preference with a communication channel:
   Via a customer call to the call center of a customer relationship management software;
   Via a web portal, by providing the ability to the partner to be able to enroll into a program;
   Using SMS or by sending registered KEYWORDS to the customer relationship management software;
   Using interactive voice response telephone system that integrates into the customer relationship software; and/or
   Using any other manual communication channel like letter, fax to the customer call center or back office processing centers to further process the partner request.
Example: A customer would like to be notified by email when his bill is ready. The system will enable the organization with that notification permission for that specific activity.

Paragraph 02
Notify the customer when an activity takes place on his/her/its account:
   Customer will inform the organization of their interest to enroll into a program using different communication channels like telephone to the call center, web portal, SMS, IVR, letter, fax.
Example: A customer would like to participate in a program that is being offered by the organization that lets him pick up a bill payment date that is convenient for him from his personal finances management point of view. The system will use the data stored in CRM data processing system to notify the customer of the specific activity that took place on his account.
Example—when a billing systems generated 100 bills during the night, the partner preferences notifications software will pick up the 100 partners (for whom the bills are ready) and further generates files for the communication software, based on the partners preferences. Out of 100 partners, 10 may want to receive the notification via email, 50 may want to receive the information by SMS, and 20 may want to receive the information via outbound call received at their home telephone numbers.

Paragraph 03
Enroll into a program with preferences:
   Customer will inform the organization of their interest to enroll into a program using different communication channels like telephone to the call center, web portal, SMS, IVR, letter, fax.
Example: A customer would like to participate in a program that is being offered by the organization that lets him pick up a bill payment date that is convenient for him from his personal finances management point of view. The system will enable the organization to enroll the customer into the program with that specific preference permission.

Paragraph 04
Consider the customer's Preferences when a specific program/customer option gets executed in an organization
   Customer will be enrolled into the program being offered by the organization and his preferences stored on his/her/its account will be considered by the data processing system.
Example: A customer participates in a “select your own bill payment date” program, in response to a campaign from the organization. When a customer enrolls into this program with his preferences, the data processing system will consider the customer data as basis, and triggers the further processes that change the customer's “selected bill payment date”.

Paragraph 05
Provide the organization with an ability to de-enroll/modify a customer from a notification or preference.
Example: When a customer expresses his intent to de-enroll from a notification preference (no more wants to be contacted by email), the system will recognize such change an act accordingly.

Paragraph 06
Provide an organization with ability to:
   Enable multiple communication channels for a customer against a notification type
Example: When a customer would like to be notified via email, SMS channels when he/she/it is close to missing the payment due date.

Paragraph 07
Provide an organization with ability to:
   Apply same notification types for multiple account that customer owns with the organization
Example: When a customer has multiple accounts with the organization, he may choose to apply the same communication channel against all accounts that he got with the organizations.

Paragraph 08
Program that creates a customer contact log in CRM system in the event of an unsuccessful message. A message failure message from the communication software becomes input for such customer contact log creation process.
Example—when a system that is responsible to send SMS messages to

partners fails, it provides log of such partners' information to CRM. CRM will create a customer contact log with appropriate reason codes about the failed message.

Paragraph 09
Program that stores data and that is further used for subsequent processes, provide partner data specific messages to the partner or to the customer service representative or the channel provided by the organization for the customer to enroll into a program.
Example: When a customer with previous fraud or theft history may not be eligible for smart meter opt-out enrollment. In such cases, a validation is performed on partner's data in the data processing system, and a custom message will be displayed at the time of enrollment.

Paragraph 10
Program that enables the organization to perform custom checks based on the business rules when a customer is planning to enroll into a notification.
Example: When a customer wants to set a notification type with a specific communication channel on a specific account, the system is capable of running customer specific business rules applicable to that scenario for that customer.

Paragraph 11
Program that enables the organization to perform custom checks based on the business rules when a customer is planning to opt in into a preference.
Example: When a customer wants to enroll into a specific program being offered by the organization, the proposed system is capable of performing customer specific business rules validation during the time of enrollment and provided customer message through a channel that the customer is trying to opt in. For example, if a customer wants to opt-out of a smart metering solution, and wants a smart meter at his home to be replaced with a normal meter, for any reasons, the system is capable of performing some checks to see if the customer has any theft and fraud history in the past. In case it finds the customer with that past history, it can provide a custom message and prevent the customer from opting in into the program).

Paragraph 12
Program that enables the organization to “Add Preference.”
When a customer calls a customer service representative or an entity in the organization that enrolls a customer into a notification/preference, a feature is provided in the software tool in CRM to set the software ready to set the preferences/notifications.

Paragraph 13
Program that enables the organization to “Show History.”

It is possible that some a preferences/notification may not be valid any more in the event that a customer opts-out of that preference. For example, in Utilities Industry, when a customer moves out of a Premise, all or some preferences associated with that customer will be ended so that the customer does not receive notification messages. It may not be required to display the old (ended) preferences in the customer contact center screen. Display of such preferences can be suppressed using the existing software tool in CRM. It is also possible using the existing software tool in CRM to display such historic preferences (ended preferences)

Paragraph 14
Program that enables the organization to “End Preference.”
It is possible that some a preferences/notification may not be valid any more in the event that a customer opts-out of that preference. For example, in Utilities Industry, when a customer moves out of a Premise, all or some preferences associated with that customer will be ended so that the customer does not receive notification messages. In such cases, the software tool in CRM will provide an ability for the customer contact center representative to manually end a customer preference.

Paragraph 15
Program that enables the organization to “Apply for Channel Value.”
It is possible that a customer may have multiple contact details (for example multiple phone numbers, email addresses etc.). It is possible that a customer may request to notify him on all the contact details in the event of a preference or notification event takes place. In such cases, the software tool in CRM provides an ability for the customer contact center representative to apply the same preference parameters to all the contact details.

Paragraph 16
Program that enables the organization to “Perform Operations on the Preferences, in the background, based on business process.”
It is required that some notification preferences will have to be ended when an event takes place or a transaction takes place in the transaction processing system like CRM or ECC. In such cases, the software tool in CRM provides an ability for automatically create preferences, end preferences, reinstate preferences, overwrite preferences, delete preferences etc., based on business rules.
Example: When a customer moves out of a house, all preferences associated with that customer against that house, will be ended, automatically.
Set a notification type with a specific communication channel on a specific account, the system is capable of running customer specific business rules applicable to that scenario for that customer.

Paragraphs by Preference/Notification:
1. A customer will be notified by a preferred communication channel when his/her/its bill is ready for payment.
In the process, the customer registers him/her/itself with the organization to be notified via a preferred communication channel (like phone, email, SMS, IVR, mail, fax), when the bill is ready.
This process also enables the customer to de-enroll from a specific notification OR modify the communication channel against a specific notification.
It also enables the customer to apply the same communication channel against all the accounts that he/she/it has with the organization.
2. A customer will be provided with a preference to participate in a program that offers “customer can select his bill due date”
In the process, the customer opts-in into a program being offered by the organization wherein he/she/it pick his own convenient date to pay his bill, every month. Such opt-in can be performed using several channels like phone, email, SMS, IVR, mail, fax.
This process also enables the customer to de-enroll from a specific preference OR de-enroll from a specific preference.
It also enables the customer to apply the same program against all the accounts that he/she/it has with the organization.
3. A customer will be notified by a preferred communication channel when his/her/its bill dispute is settled by the organization.
In the process, the customer registers him/her/itself with the organization to be notified via a preferred communication channel (like phone, email, SMS, IVR, mail, fax), when the bill dispute is settled.
This process also enables the customer to de-enroll from a specific notification OR modify the communication channel against a specific notification.
It also enables the customer to apply the same communication channel against all the accounts that he/she/it has with the organization.
4. A customer will be notified by a preferred communication channel when his/her its/usage threshold is reached for a specific account,
In the process, the customer registers him/her/itself with the organization to be notified via a preferred communication channel (like phone, email, SMS, IVR, mail, fax), when the usage reaches a pre-set threshold for a specific account.
This process also enables the customer to de-enroll from a specific notification OR modify the communication channel against a specific notification.
It also enables the customer to apply the same communication channel against all the accounts that he/she/it has with the organization.
5. A customer will be notified by a preferred communication channel when his/her/its load will be limited when the overall Utility's load level reaches a critical stage.
In the process, the customer registers him/her/itself with the organization to be notified via a preferred communication channel (like phone, email, SMS, IVR, mail, fax), when the load level for the organization reaches a critical level. At the same time, the customer also empowers the Utility to limit his load to a specific number so that the overall load burden on the system is reduced.
This process also enables the customer to de-enroll from a specific notification OR modify the communication channel against a specific notification.
It also enable the customer to apply the same communication channel preference against all the accounts that he/she/it has with the organization.
6. A customer will be notified by a preferred communication channel when the organization plans for a planned power outage in his/her/its area.
In the process, the customer registers him/her/itself with the organization to be notified via a preferred communication channel (like phone, email, SMS, IVR, mail, fax), when the organization has a planned outage at his premise.
This process also enables the customer to de-enroll from a specific notification OR modify the communication channel against a specific notification.
It also enables the customer to apply the same communication channel against all the accounts that he/she/it has with the organization.
7. A customer will be notified by a preferred communication channel when the power outage is restored in his/her/its premise.
In the process, the customer registers him/her/itself with the organization to be notified via a preferred communication channel (like phone, email, SMS, IVR, mail, fax), when the organization has resolved the power outage at his premise.
This process also enables the customer to de-enroll from a specific notification OR modify the communication channel against a specific notification.
It also enables the customer to apply the same communication channel against all the accounts that he/she/it has with the organization.
8. A customer will be notified by a preferred communication channel when a payment was posted against his/her/its account in the organization's records.
In the process, the customer registers him/her/itself with the organization to be notified via a preferred communication channel (like phone, email, SMS, IVR, mail, fax), when the organization has realized a payment from his account against one or more accounts in the organization's records.
This process also enables the customer to de-enroll from a specific notification OR modify the communication channel against a specific notification.
It also enables the customer to apply the same communication channel against all the accounts that he/she/it has with the organization.
9. A customer will be notified by a preferred communication channel when his/her/its account reaches a threshold wherein it will be forced to a service disconnection.
In the process, the customer registers him/her/itself with the organization to be notified via a preferred communication channel (like phone, email, SMS, IVR, mail, fax), when his/her/its account reaches a threshold wherein it will be forced for a disconnection of service for a reason that he/she/it had not fulfilled the payment obligation.
This process also enables the customer to de-enroll from a specific notification OR modify the communication channel against a specific notification.
It also enables the customer to apply the same communication channel against all the accounts that he/she/it has with the organization.
10. A customer will be provided with a preference to participate in a program that offers “opt in” into a program being offered by the organization.
In the process, the customer opts-in into a program being offered by the organization wherein he/she/it opts-in into a program being offered by the organization in the areas like ‘time-of-use-billing” using a smart meter at his/her/its location. Such opt-in can be performed using several channels like phone, email, SMS, IVR, mail, fax. Based on this preference information provided by the customer, the company will enroll him into the time-of-use-billing program being offered to its customers.
This process also enables the customer to de-enroll from a specific preference OR de-enroll from a specific preference.
It also enables the customer to apply the same program against all the accounts that he/she/it has with the organization.
11. A customer will be provided with a preference to participate in a program that offers “opt out” into a program being offered by the organization.
In the process, the customer opts-out of a program being offered by the organization wherein he/she/it opts-out of a program being offered by the organization in the areas like ‘time-of-use-billing” using a smart meter at his/her/its location. Such opt-in can be performed using several channels like phone, email, SMS, IVR, mail, fax. Based on this preference information provided by the customer, the company will remove the customer from time-of-use-billing program being offered to him/her/it.
This process also enables the customer to de-enroll from a specific preference OR de-enroll from a specific preference.
It also enables the customer to apply the same program against all the accounts that he/she/it has with the organization.
12. A customer will be contacted via a preferred communication channel when his/her/its complaint or dispute is settled by the organization on a specific account.
In the process, the customer registers him/her/itself with the organization to be notified via a preferred communication channel (like phone, email, SMS, IVR, mail, fax), when his/her/its complaint or dispute is settled by the company.
This process also enables the customer to de-enroll from a specific notification OR modify the communication channel against a specific notification.
It also enables the customer to apply the same communication channel against all the accounts that he/she/it has with the organization.
13. A customer will be contacted for any marketing related campaigns with reference to his accounts or irrespective of his/her/its accounts.
In the process, the customer registers him/her/itself with the organization to be contacted by a specific communication channel (like phone, email, SMS, IVR, mail, fax), when a specific marketing campaign is being launched by the organization.
This process also enables the customer to de-enroll from a specific notification OR modify the communication channel against a specific notification.
It also enables the customer to apply the same communication channel against all the accounts that he/she/it has with the organization.
14. A customer SHOULD NOT be contacted for any marketing related campaigns with reference to his accounts or irrespective of his/her/its accounts.
In the process, the customer registers him/her/itself with the organization to NOT TO contact him/her/it by a specific communication channel (like phone, email, SMS, IVR, mail, fax), when a specific marketing campaign is being launched by the organization.
This process also enables the customer to de-enroll from a specific notification OR modify the communication channel against a specific notification.
It also enables the customer to apply the same communication channel against all the accounts that he/she/it has with the organization.
15. Demand Response Events—A customer will be contact via preferred communication channel when the organization is planning to raise a Demand Response Event.
16. Prepayment—A customer will be contacted via preferred communication channel when his prepayment account balance reaches a pre-defined value. That notification to the customer will enable him or her to keep track of his or her consumption, plan for reloading the prepayment account, etc.

Illustration
For example, in Utilities industry, a customer would like to be notified via an e-mail when his bill is ready for viewing on the utility company's portal. In this case, explicitly provides permission to the Utility Company to perform the activity subsequent to an event. Utility, Telecommunication, Banking companies stores such permission or authorization in its data processing system, for the specific activity. Some of the activities provided below with examples:
1. Consumption and Billing—Partner want to be informed when his bill is ready for a specific account or address, via a specific communication channel (for example via SMS, email, fax, phone call, etc.).
2. Outage Alerts & Resolution—when am electric outage or restoration (planned or unplanned) has taken place a partner's location, he/she would like to be notified via a specific communication channel (for example via SMS, email, fax, phone call, etc.).
3. Partner Preferred Payment Due Date—partner would like to set up a preferred payment date for his bills and the bill notification to be sent to him via a specific communication channel (for example via SMS, email, fax, phone call, etc.).
4. Notifications—notifications that the organization would like to store that pertains to the partner; for example, when customer would like to be notified when his electricity consumption has reached a threshold level on a specific account.
5. Advanced Metering Infrastructure—(Accept an AMI Meter at his/her location—Yes or No): Despite the increasing aware of smart meters or advanced meters being installed by the Utilities companies, there are still customers who would not want to have a smart meter to be installed at their home/office. When such a customer calls up the Utility and requests to keep him out of the smart metering program, the Utility should store the customer preference in its data processing system.
6. Account Payables—When a business partner is reaching a specific business rule and will be about to be disconnected from service, if he does not pay his bill. At that point in time, he would like to be informed via a specific communication channel ((for example via SMS, email, fax, phone call, etc.).
7. Demand Response—Utility companies are focusing on promoting conservation of energy among customers. They enroll customers into energy conservation programs. On a specific day when the utility company may need some customers (who have enrolled into that program) to reduce the consumption by turning off some equipment in the home. In such cases, the utility company will inform the customers, in advance, about the proposed demand response event.
8. Prepayment—Utility companies promote prepaid cards for energy consumption. When a customer sets up such a prepaid account with the utility company, the company can set up preferences for the customer in such a way that when his prepaid account reaches a certain value, he or she will be communicated with based on his or her preferred channel.
A partner may have one or several objects or accounts with the service provider and may want to set up preferences for specific objects or accounts only. For example, in Utilities industry, a customer who owns two or more homes (he lives in one house and uses the other home as vacation home) may want to receive an alert on his mobile phone in the form of an SMS when there is an electricity theft or suspicious electricity consumption activity going on at his vacation home.

### CONCLUSION

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

I claim:

1. A method for managing customer communication preferences, comprising:
monitoring, by an electronic apparatus, a plurality of events associated with a plurality of customers;
detecting, by the electronic apparatus, a first event associated with a first customer;
determining, by the electronic apparatus and from an electronic database, that the first customer has a stored preferred channel associated with communication of the first event to the first customer; and
directing, by the electronic apparatus, the communication of the first event to the first customer via the stored preferred channel associated with communication of the first event to the first customer.

2. The method of claim 1, further comprising:
detecting, by the electronic apparatus, a second event associated with the first customer, the second event being different from the first event;
determining, by the electronic apparatus and from an electronic database, that the first customer has a stored preferred channel associated with communication of the second event to the first customer, the stored preferred channel associated with communication of the second event being different from the stored preferred channel associated with communication of the first event; and
directing, by the electronic apparatus, the communication of the second event to the first customer via the stored preferred channel associated with communication of the second event.

3. The method of claim 1, further comprising expanding, by the electronic apparatus, the electronic database for storage of preferred channels associated with communication of a plurality of events to the first customer.

4. The method of claim 3, further comprising directing, by the electronic apparatus, that one or more requests be sent to the first customer to request the customer's preferred channels associated with communication of the plurality of events to the customer.

5. The method of claim 4, further comprising directing, by the electronic apparatus, storage in the expanded electronic database of the preferred channels associated with communication of the plurality of events to the first customer, the preferred channels being received in response to the one or more requests to the first customer.

6. The method of claim 5, further comprising directing, by the electronic apparatus, that data associated within unsuccessful communications of events to the first customer via the stored preferred channels be stored in the expanded electronic database.

7. The method of claim 1, wherein identifying a first event associated with a first customer includes identifying a scheduled first event associated with the first customer, and wherein directing the communication of the first event to the first customer via the stored preferred channel includes directing the communication of the scheduled first event to the first customer via the stored preferred channel prior to occurrence of the scheduled first event.

8. A computer system for managing customer communication preferences, comprising:
a processor;
a memory; and
a program comprising a plurality of instructions stored in the memory that is executed by the processor to:
monitor a plurality of events associated with a plurality of customers;
detect a first event associated with a first customer;
determine that the first customer has a stored preferred channel associated with communication of the first event to the first customer; and
direct the communication of the first event to the first customer via the stored preferred channel associated with communication of the first event to the first customer.

9. The computer system of claim 8, wherein the plurality of instructions further comprises instructions that are executed by the processor to:
detect a second event associated with the first customer, the second event being different from the first event;
determine that the first customer has a stored preferred channel associated with communication of the second event to the first customer, the stored preferred channel associated with communication of the second event being different from the stored preferred channel associated with communication of the first event; and
direct the communication of the second event to the first customer via the stored preferred channel associated with communication of the second event.

10. The computer system of claim 8, wherein the plurality of instructions further comprises instructions that are executed by the processor to expand the electronic database for storage of preferred channels associated with communication of a plurality of events to the first customer.

11. The computer system of claim 10, wherein the plurality of instructions further comprises instructions that are executed by the processor to direct that one or more requests be sent to the first customer to request the customer's preferred channels associated with communication of the plurality of events to the customer.

12. The computer system of claim 11, wherein the plurality of instructions further comprises instructions that are executed by the processor to direct storage in the expanded electronic database of the preferred channels associated with communication of the plurality of events to the first customer, the preferred channels being received in response to the one or more requests to the first customer.

13. The computer system of claim 12, wherein the plurality of instructions further comprises instructions that are executed by the processor to:
detect a third event associated with the first customer, the third event being different from the first and second events;
determine whether one or more preferred channels that are stored in the electronic database need to be updated based on the detected third event;
direct the requesting for one or more updated preferred channels when it is determined that the one or more preferred channels that are stored in the electronic database need to be updated; and
direct that the one or more updated preferred channels received in response to the request for one or more updated preferred channels be stored in the electronic database.

14. A computer program product for managing customer communication preferences, the computer program product comprising:
at least one computer readable storage medium having computer readable program instructions embodied therewith, the computer readable program instructions, when read by a processor, being configured to:
monitor a plurality of events associated with a plurality of customers;
detect a first event associated with a first customer;
determine that the first customer has a stored preferred channel associated with communication of the first event to the first customer; and
direct the communication of the first event to the first customer via the stored preferred channel associated with communication of the first event to the first customer.

15. The computer program product of claim 14, wherein the computer readable program instructions, when read by a processor, are further configured to:
detect a second event associated with the first customer, the second event being different from the first event;
determine that the first customer has a stored preferred channel associated with communication of the second event to the first customer, the stored preferred channel associated with communication of the second event being different from the stored preferred channel associated with communication of the first event; and
direct the communication of the second event to the first customer via the stored preferred channel associated with communication of the second event.

16. The computer program product of claim 14, wherein the computer readable program instructions, when read by a processor, are further configured to expand the electronic database for storage of preferred channels associated with communication of a plurality of events to the first customer.

17. The computer program product of claim 16, wherein the computer readable program instructions, when read by a processor, are further configured to direct that one or more requests be sent to the first customer to request the customer's preferred channels associated with communication of the plurality of events to the customer.

18. The computer program product of claim 17, wherein the computer readable program instructions, when read by a processor, are further configured to direct storage in the expanded electronic database of the preferred channels associated with communication of the plurality of events to the first customer, the preferred channels being received in response to the one or more requests to the first customer.

19. The computer program product of claim 14, wherein the computer readable program instructions, when read by a processor, are further configured to direct that data associated within unsuccessful communications of events to the first customer via the stored preferred channels be stored in the expanded electronic database.

20. The computer program product of claim 14, wherein the computer readable program instructions, when read by a processor, are further configured to:
detect a third event associated with the first customer, the third event being different from the first and second events;
determine whether one or more preferred channels that are stored in the electronic database need to be deleted based on the detected third event;
direct the deletion of the one or more preferred channels when it is determined that the one or more preferred channels that are stored in the electronic database need to be deleted;
direct the requesting for one or more new preferred channels to replace the deleted one or more preferred channels; and
direct that the one or more new preferred channels received in response to the request for one or more new preferred channels be stored in the electronic database.
